(19) United States
(12) Patent Application Publication
(10) Pub. No.: US 2006/0137189 A1
(43) Pub. Date: Jun. 29, 2006

(54) Saw guide and guide follower

(75) Inventor: Douglas R. Dole, Whitehouse Station, NJ (US)

Correspondence Address: SYNNESTVEDT & LECHNER, LLP, 2600 ARAMARK TOWER, 1101 MARKET STREET, PHILADELPHIA, PA, 191072950, US

(73) Assignee: Victaulic Company of America, Easton, PA (US)

(21) Appl. No.: 11/022,706

(22) Filed: Dec. 27, 2004

(51) Int. Cl. B23D 21/06

(52) U.S. Cl. 30/100

(57) ABSTRACT

A guide and a guide follower for cutting pipes are disclosed. The guide has a chain with ends attached to movable jaws. The jaws are mounted on a pair of locking pliers. The chain is positionable circumferentially around the pipe. A plurality of disks are mounted lengthwise along the chain in spaced relation to one another. The disks have surfaces that engage the pipe and edges that face away from the pipe and engage the guide follower mounted on a saw. The guide follower is a channel with flanges spaced apart so as to receive the disk edges and allow the channel to pass along the disks but not deviate from the intended line of cut. A plurality of support disks are positioned on an opposite side of the chain. The support disks engage the pipe and stabilize the guide when it is placed under tension by the pliers.

### FIELD OF THE INVENTION

This invention relates to guides and guide followers for use with cutting tools to cut pipe or other elongated items.

### BACKGROUND OF THE INVENTION

In the absence of jigs or other tooling, it is difficult to cut large elongated items such as large diameter pipes, non-round tubing or solid rods to length by hand with a saw and produce a square cut. This is especially true for operations in the field where, at most, there will be a rigid platform to which the item to be cut may be clamped.

Substantially due to the large size and curved or irregularly shaped surface of pipes, tubes and rods, it is difficult to control a power saw by hand and produce a square cut. As the saw traverses around the perimeter of the item, it is not unusual for the saw to drift from the intended line of cut due to the weight, torque and vibration of the saw. Furthermore, the cut line is not always immediately visible to the saw operator as the cut progresses due to the curvature or other shape of the item being cut. It would be advantageous to have a guide that can be used in the field and that is adaptable to various size and shaped pipes, tubes and rods for guiding a saw to produce a square cut.

### SUMMARY OF THE INVENTION

Throughout the application the term “pipe” is used as a matter of convenience and economy to refer to any type of elongated item, including, by way of example, pipes, tubes (having round and non-round cross sections), rods as well as solid, closed or open section columns and beams for which a square cross-sectional cut is desired. It is understood that the invention is not confined only to pipes per se.

The invention concerns a guide positionable around a pipe for guiding a cutting tool such as a saw used to cut the pipe. The cutting tool has a guide follower mounted thereon that is engageable with the guide. The guide comprises a flexible, elongated member having first and second ends oppositely disposed. The elongated member is positionable substantially surrounding the pipe. A plurality of guide bodies are mounted on the elongated member. Each of the guide bodies has an edge portion positionable projecting away from the pipe and adapted for engagement with the guide follower. A latching device is positioned between the first and second ends of the elongated member. The latch is adapted to align and interconnect the elongated member's first and second ends and secure it around the pipe.

The latching device may comprise a first jaw portion attached to the first end of the elongated member and a second jaw portion releasably engageable with the second end of the elongated member. The first and second jaw portions are movable toward one another to draw the elongated member around the pipe. The first and second jaw portions are also movable away from one another to release the pipe from the elongated member. Preferably the jaw portions are attached to a locking pliers. The first and second jaw portions are movable toward one another upon closing of the pliers to draw the elongated member around the pipe, and movable and away from one another upon opening of the pliers to release the pipe from the elongated member.

Preferably, the latching device also comprises a tensioning means for adjusting the tension of the elongated member when it surrounds the pipe.

The invention also includes a guide follower mountable on a cutting tool, such as a hand-held power saw. The guide follower is engageable with a guide having an outwardly extending edge or edges. The guide follower comprises an elongated channel having a first flange attachable to the cutting tool, and a second flange positioned in spaced relation to the first flange. The flanges define a space between them that is sized so as to receive the edge or edges of the guide. Engagement of the guide follower with the edge or edges of the guide directs the tool along a path defined by the guide.

### BRIEF DESCRIPTION OF THE DRAWINGS

FIG. 1 is an end view of a guide and a guide follower according to the invention in use to guide a saw cutting a pipe;

FIG. 2 is a partial sectional side view of the guide and the guide follower taken at line 2-2 of FIG. 1;

FIGS. 3, 3A, 3B and 4 are partial sectional side views of the guide presented on an enlarged scale;

FIG. 5 is a partial sectional top view taken at line 5-5 of FIG. 3;

FIG. 6 is a partial sectional side view of a portion of the guide showing an alternate embodiment; and

FIG. 7 is a partial sectional view taken at line 7-7 of FIG. 6.

### DETAILED DESCRIPTION OF THE PREFERRED EMBODIMENTS

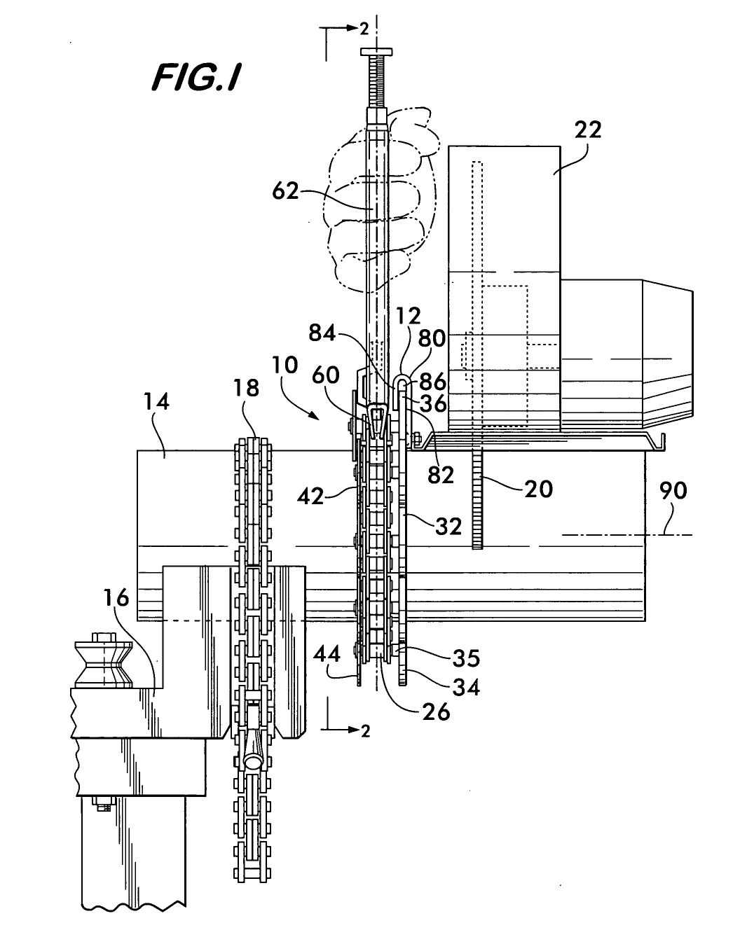

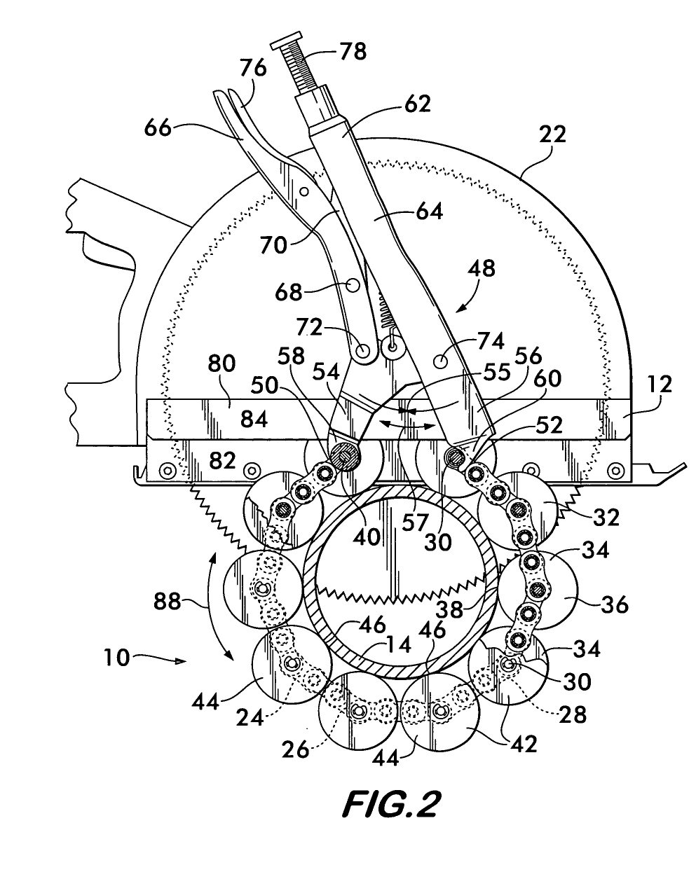

FIGS. 1 and 2 illustrate the use of a guide 10 and guide follower 12 to cut a pipe 14. As shown in FIG. 1, pipe 14 is clamped to a workbench 16 by means of a chain clamp 18 to provide rigid support to the pipe for the cutting process. As described in detail below, the guide 10 is manually positioned around the pipe 14 at a position offset from the desired cut line 20. A saw 22, on which the guide follower 12 is mounted, is used to effect the cut by engaging the guide follower 12 with the guide 10. Saw 22 is described herein by way of example only, it being understood that the guide 10 and guide follower 12 may be used with any cutting tool such as a hand saw, a cutting torch, a plasma cutter as well as a roller cutter.

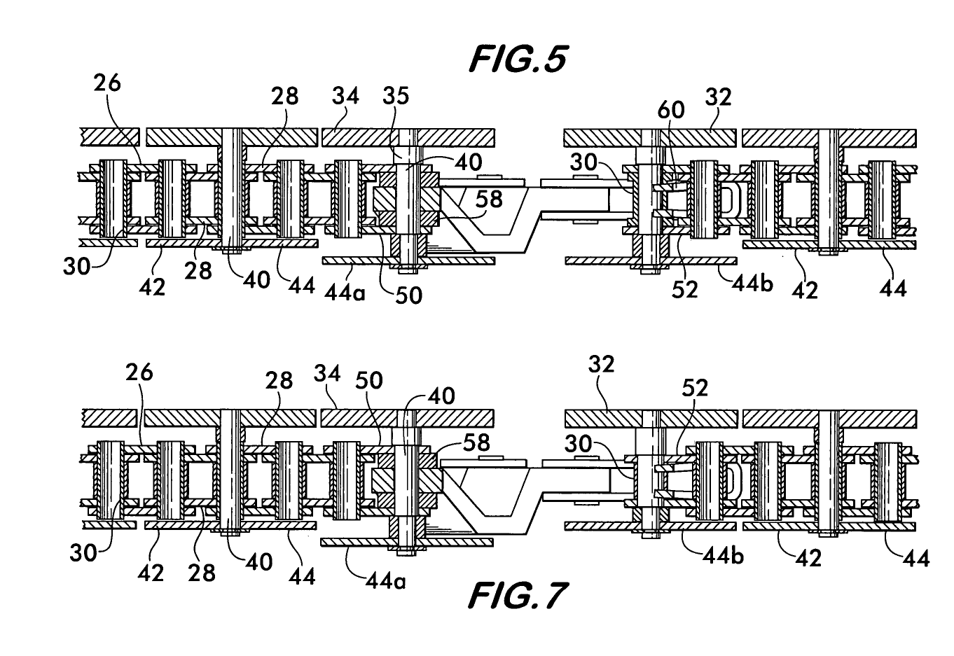

As best shown in FIG. 2, guide 10 comprises an elongated flexible member 24, preferably in the form of a hollow pin roller chain 26. As shown in FIG. 5, chain 26 is formed from a plurality of links 28 pivotably attached to one another end to end by pins 30. The hollow pin roller chain is preferred for the elongated member 24 because it provides excellent flexibility, high-tensile strength, is commonly available and is readily adaptable to accommodate the other components comprising the guide. The flexibility of chain 26 allows the guide 10 to conform to virtually any shape or curvature, while the high strength of the chain allows the guide 10 to withstand significant tension force applied to secure it to the pipe 14 as described below.

With reference again to FIG. 2, guide 10 further comprises a plurality of guide bodies 32 mounted on the chain 26. Guide bodies 32 are preferably in the form of guide disks 34 positioned in spaced apart relation along the length of the chain. Guide disks 34 each have an edge portion 36 that is positionable projecting away from the pipe 14 and a surface portion 38, positioned opposite to the edge portion 38. Edge portions 36 are engageable with the guide follower 12 as described below, and surface portions 38 are engageable with the pipe 14. As shown in FIG. 5, guide disks 34 are rotatably mounted on chain 26 using axles 40 that pass through the pins 30 joining the links 28 pivotably to one another. Spacers 35 positioned between the guide disks 34 and the links 28 keep the guide disks at a desired separation distance from the chain 26.

As further shown in FIGS. 2 and 5, a plurality of support bodies 42 are also mounted on chain 26. Preferably, support bodies 42 take the form of support disks 44 and are mounted on the same axles 40 as are the guide disks 34. The support disks 44 are also rotatable on chain 26 and have surface portions 46 engageable with the pipe 14. Support disks 44 are mounted on the opposite side of chain 26 from the guide disks 34, have the same diameter as the guide disks, and help to stabilize the guide 10 when it is engaged around the pipe 14. Support disks 44 also maintain the guide disks 34 perpendicular to the surface of pipe 14.

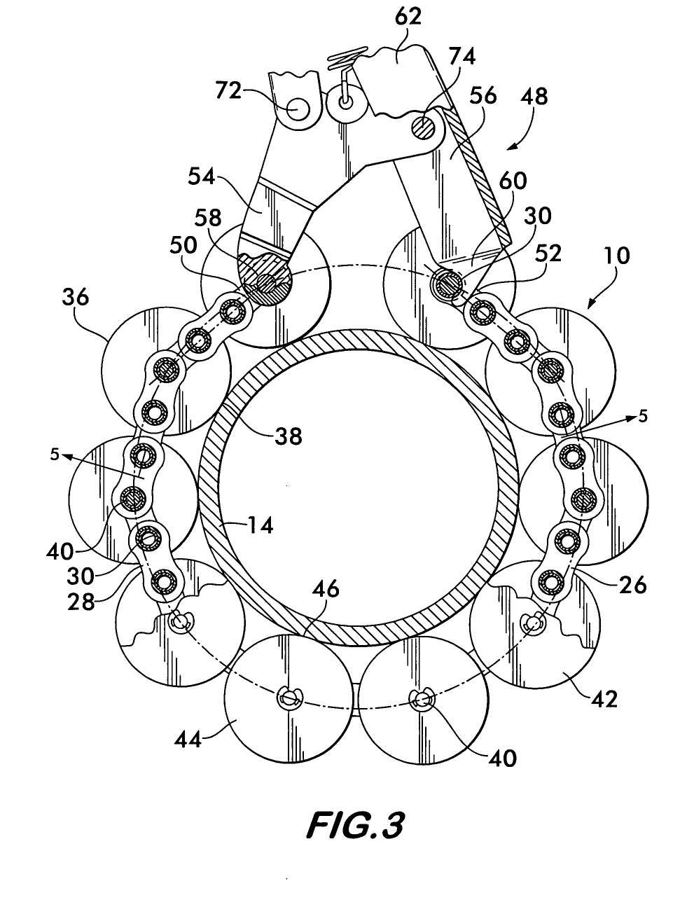

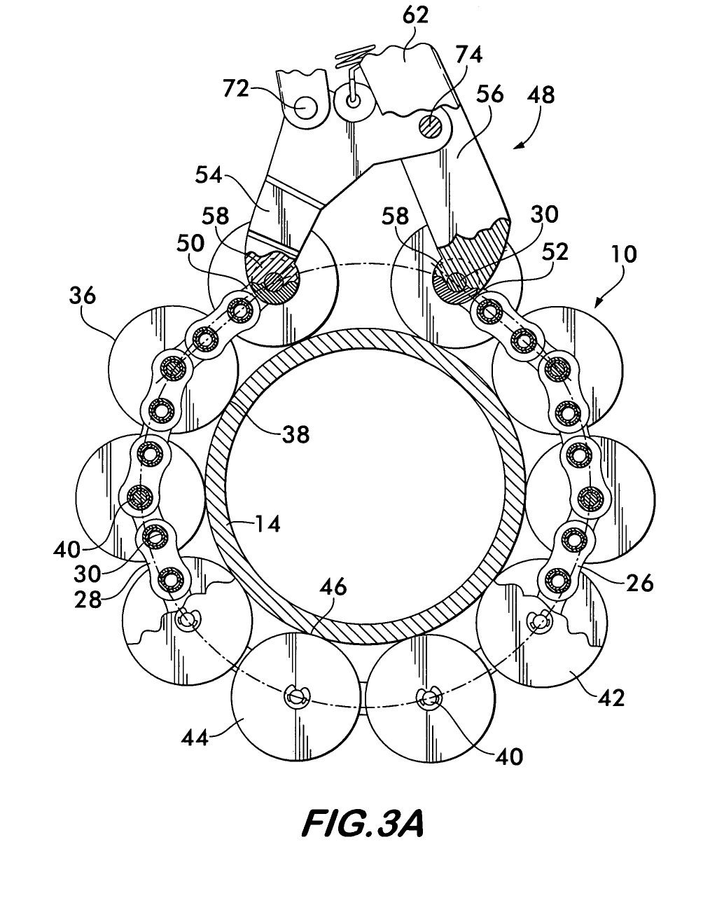

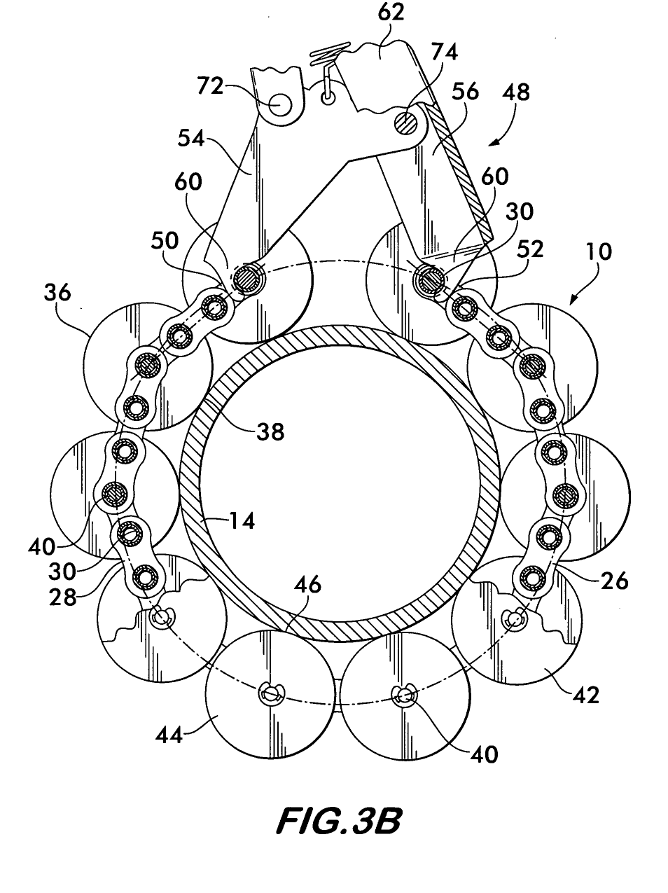

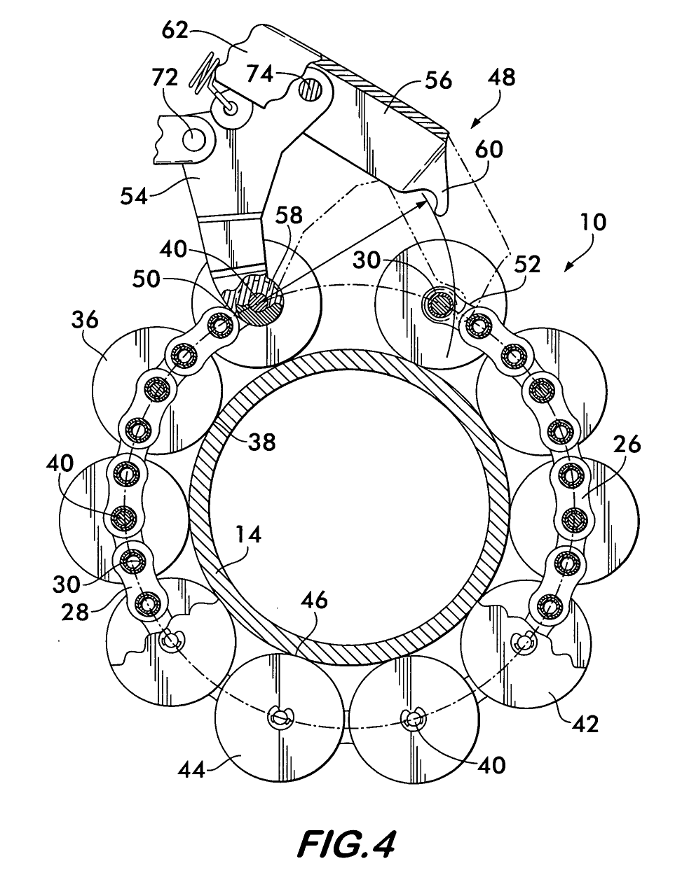

Guide 10 also includes a latching device 48, shown in FIG. 2, and positioned between ends 50 and 52 of chain 26. Preferably, latching device 48 comprises first and second jaw portions 54 and 56 that engage the ends 50 and 52 of chain 26 and secure it around the pipe 14. The jaw portions are movable toward and away from one another as illustrated by arrows 55 and 57. Motion of the jaw portions toward one another draws the guide 10 around the pipe 14, engaging the surface portions 38 and 46 of the guide disks 34 and the support disks 44 respectively, with the pipe 14. Motion of the jaw portions away from one another releases the pipe 14 from the guide 10. As shown by a comparison of FIGS. 3 and 4, it is preferred that one jaw portion, 54 for example, be attached to end 50 of chain 26, while the other jaw portion 56 is releasably engageable with the opposite end 52 of the chain. To effect this configuration, jaw portion 54 has a lug 58 that receives an axle 40 at the end 50 of chain 26 (see also FIG. 5) for pivoting attachment of the jaw portion 54 to the chain. Being releasably engageable with the chain, jaw portion 56 has a hook 60 sized to receive a pin 30 at or near the opposite end 52 of chain 26. As shown in FIG. 4, hook 60 may be readily disengaged from the pin 30 by relieving any tension on the jaw portions and the chain, then moving the jaw portions away from one another and rotating the jaw portion 56 away from the chain 26.

Having one jaw portion attached to the chain 26 prevents the chain from being separated from the jaw portions and lost, while allowing the other jaw portion to be releasably engageable allows the chain to be conveniently wrapped around a pipe at any point along its length without need for access to a free end of the pipe. Alternately, as shown in FIG. 3A, it is also feasible to attach jaw portions 54 and 56 to each end 50 and 52 of the chain 26. This configuration is effected by having a lug 58 mounted on each jaw portion. In another embodiment, shown in FIG. 3B, both jaw portions 54 and 56 are releasably engageable with ends 50 and 52 of chain 26. To effect this configuration hooks 60 are mounted on each jaw portion.

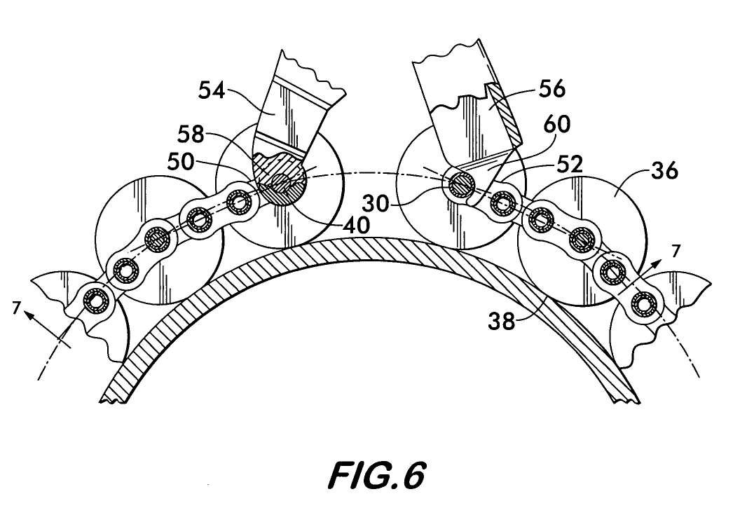

Depending upon the size and design of the jaw portions, the geometry and length of the chain as well as the number and the spacing of the disks on the chain, it may be advantageous to position one or more support disks 44 further outboard from the others. An example of this is shown in a comparison of FIGS. 5 and 7. In FIG. 5, which illustrates a guide having an even number of disks 44 (see also FIG. 3), support disks 44a and 44b at opposite ends 50 and 52 of the chain 26 are spaced out of alignment with the remaining support disks, whereas in FIG. 7, which illustrates a guide 10 shown in FIG. 6 and having an odd number of disks 44, only one disk, 44a need be displaced to accommodate the jaw portion 54.

As best shown in FIG. 2, jaw portions 54 and 56 are preferably mounted on a pair of locking pliers 62. Locking pliers 62 have a handle 64 on which jaw portion 56 is mounted. An actuating lever 66 is pivotally attached to handle 64 at a first pivot point 68 mounted on a slidable link 70 extending from the handle. Actuating lever 66 is also attached to jaw portion 54 at a second pivot point 72. Jaw portion 54 is also pivotally attached to handle 64 at a third pivot point 74.

The geometry of the pivot points 68, 72 and 74 is such that upon closing of the pliers 62 by drawing actuating lever 66 toward handle 64, jaw portion 54 pivots about pivot point 74 and moves toward jaw portion 56. This applies tension to the chain 26 and draws the guide 10 around the pipe 14. The pliers 62 locks in the closed position as is well known for this tool, thereby maintaining the tension on chain 26 and securing surface portions 38 and 46 of disks 34 and 44 against the pipe 14. Pliers 62 may be opened to release the pipe by compressing a release lever 76 against actuating lever 66 to allow the actuating lever to move away from the handle 64. A jackscrew 78 is threadedly mounted within handle 64 and is engaged with the slidable link 70. Advance or retreat of the jackscrew 78 into the handle 64 moves the slidable link 70 toward and away, respectively, from jaw portion 56. Motion of link 70 in turn, moves pivot points 68 and 72. This affects the range of motion of jaw portion 54 in response to motion of actuating lever 66, thereby allowing the tension applied to the chain to be adjusted up or down when the disks 34 and 44 are engaged with the pipe 14.

Providing for adjustability of the chain tension is advantageous because it allows the guide 10 to readily accommodate the tolerance variations typically encountered in the outer diameters of mass produced pipes. Furthermore, there is generally sufficient adjustability in the device to allow it to accommodate a range of diameters and their tolerances. The adjustability thus allows the guide 10 to be used on families of pipes closely related in size, as is found among various standards and among pipes made of different materials.

Locking pliers 62 is an example of an adjustable tensioning means for applying tension to and releasing tension from chain 26. Other example tensioning means include screw clamps, vices, chain pullers, chain tensioners spring loaded over center clamps and draw hooks.

FIGS. 1 and 2 best illustrate the guide follower 12 according to the invention. Guide follower 12 preferably comprises an elongated channel 80 that has two flanges 82 and 84 positioned in spaced apart relation. One flange, 82 is attachable to the saw 22 or other tool. Together, the two flanges define a space 86 between them that is adapted to receive the outwardly projecting edge portions 36 of disks 34. Tolerance between the flanges 82 and 84 and the disks 34 is such that the channel 80 slides freely over the disks but does not have significant lateral free play thereby preventing the saw 22 from straying significantly from the cut line 20.

In operation, as shown in FIG. 1, the pipe 14 to be cut is clamped to the work bench 16, for example, using a chain clamp 18. As shown in FIG. 4, the guide 10 is wrapped around the pipe 14. Hook 60 is engaged with pin 30 at end 52 of chain 26 as shown in FIG. 3, and actuating lever 66 of pliers 62 is manually squeezed to apply tension to the chain and engage the disks 34 and 44 with the pipe as shown in FIGS. 1 and 2. Before full tension is applied to chain 26 and the pliers 62 locked, it is convenient to rock the guide 10 back and forth around the circumference of pipe 14 as indicated by arrow 88 in FIG. 2. Rocking the guide around the pipe under light tension causes the guide disks 44 to align perpendicularly to the pipe axis 90 and ensure a square end cut. The rocking motion of the guide 10 around the pipe is facilitated by the fact that the rollers 34 and 44 are rotatably mounted on chain 26. Once the alignment of the guide disks is satisfactory, the actuating lever 66 is squeezed home to lock the chain 26 around the pipe 14, the desired tension having been set using jackscrew 78.

With the guide 10 securely in place surrounding the pipe 14, saw 22 is then applied to effect the cut. As shown in FIGS. 1 and 2, the saw 22 is positioned so that the edge portions 36 of disks 34 are positioned within the space 86 defined by flanges 82 and 84 of channel 80 as the saw 22 traverse the circumference of pipe 14. As noted above, the space 86 is sized so that the disks 34 pass freely between the flanges 82 and 84, but the tolerance between the space 86 and the disks 34 is such that significant deviation of the saw from the intended cut line 20 is not permitted. Upon completion of the cut, release lever 76 is pressed to unlock pliers 62, releasing tension on chain 26 and allowing hook 60 to release from engagement with pin 30. The guide 10 may then be removed from pipe 14.

The guide according to the invention provides an inexpensive, reliable, self aligning, adaptable, easy to use device that ensures a square cut to pipes of any cross-sectional shape whether used during shop fabrication or under primitive conditions in the field.

What is claimed is:

1. A guide positionable around a pipe for guiding a cutting device used to cut said pipe, said cutting device having a guide follower mounted thereon and engageable with said guide, said guide comprising:
a flexible, elongated member having first and second ends oppositely disposed, said elongated member being positionable substantially surrounding said pipe;
a plurality of guide bodies mounted on said elongated member, each of said guide bodies having an edge portion positionable projecting away from said pipe and adapted for engagement with said guide follower; and
a latching device interconnecting said first and second ends and securing said elongated member around said pipe.

2. A guide according to claim 1, wherein each of said guide bodies further comprises a surface portion engageable with said pipe.

3. A guide according to claim 1, wherein said latching device comprises a first jaw portion attached to said first end of said elongated member and a second jaw portion attached to said second end of said elongated member, said first and second jaw portions being movable relative to one another so as to draw said elongated member around said pipe, said first and second jaw portions also being movable relative to one another so as to release said pipe from said elongated member.

4. A guide according to claim 1, wherein said latching device comprises a first jaw portion releasably engageable with said first end of said elongated member and a second jaw portion releasably engageable with said second end of said elongated member, said first and second jaw portions being movable relative to one another so as to draw said elongated member around said pipe, said first and second jaw portions also being movable relative to one another so as to release said pipe from said elongated member.

5. A guide according to claim 1, wherein said latching device comprises a first jaw portion attached to said first end of said elongated member and a second jaw portion releasably engageable with said second end of said elongated member, said first and second jaw portions being movable relative to one another to draw said elongated member around said pipe, said first and second jaw portions also being movable relative to one another to release said pipe from said elongated member.

6. A guide according to claim 1, wherein said latching device comprises a locking pliers having a first jaw portion attached to said first end of said elongated member and a second jaw portion releasably engageable with said second end of said elongated member, said first and second jaw portions being movable toward one another upon closing of said pliers to draw said elongated member around said pipe, said first and second jaw portions being movable and away from one another upon opening of said pliers to release said pipe from said elongated member.

7. A guide according to claim 1, wherein said elongated member comprises a chain.

8. A guide according to claim 1, wherein each of said guide bodies comprises a disk.

9. A guide according to claim 8, wherein said disks are positioned in spaced apart relation along said elongated member.

10. A guide according to claim 8, wherein said disks are rotatably mounted on said elongated member.

11. A guide according to claim 2, further comprising a plurality of support bodies mounted on said elongated member adjacent to said guide bodies, each of said support bodies having a surface portion engageable with said pipe.

12. A guide according to claim 11, wherein each of said support bodies comprises a disk.

13. A guide according to claim 12, wherein each of said disks is rotatably mounted on said elongated member.

14. A guide according to claim 11, wherein said latching device comprises a first jaw portion attached to said first end of said elongated member, and a second jaw portion releasably engageable with said second end of said elongated member, said first and second jaw portions being movable toward one another to draw said guide bodies and said support bodies into engagement with said pipe, said first and second jaw portions being movable away from one another to release said pipe from engagement with said guide bodies and said support bodies.

15. A guide according to claim 1, wherein said latching device further comprises a tensioning means for adjusting the tension of said elongated member when surrounding said pipe.

16. A guide positionable around a pipe for guiding a cutting device used to cut said pipe, said cutting device having an open channel mounted thereon engageable with said guide, said guide comprising:
a flexible chain having first and second ends oppositely disposed, said chain being positionable substantially surrounding said pipe;
a plurality of guide disks mounted on said chain one behind another, each of said guide disks having an edge portion positionable projecting away from said pipe and adapted to engage said channel, each of said guide disks also having a surface portion positioned opposite to said edge portion and engageable with said pipe; and
a locking pliers having a first jaw portion attached to said first end of said chain and a second jaw portion releasably engageable with said second end of said chain, said first and second jaw portions being movable toward one another upon closing of said pliers to draw said chain around said pipe and engage said surfaces of said guide disks with said pipe, said first and second jaw portions being movable away from one another upon opening of said pliers to release said pipe from engagement with said guide disks.

17. A guide according to claim 16, wherein said disks are rotatably mounted on said chain.

18. A guide according to claim 16, wherein said disks are positioned in spaced apart relation along said chain.

19. A guide according to claim 17, further comprising a plurality of support disks mounted on said chain on an opposite side from said guide disks, each of said support disks having a surface portion engageable with said pipe.

20. A guide according to claim 19, wherein said support disks are rotatably mounted on said chain.

21. A guide according to claim 16, wherein said pliers further comprises tensioning means for adjusting the tension in said chain when said chain surrounds said pipe.

22. A guide positionable around a pipe for guiding a cutting device used to cut said pipe, said cutting device having a guide follower mounted thereon and engageable with said guide, said guide comprising:
a flexible, elongated member having first and second ends oppositely disposed, said elongated member being positionable substantially surrounding said pipe;
a plurality of guide bodies mounted on said elongated member, each of said guide bodies having an edge portion projecting away from said pipe and being engageable with said guide follower; and
an adjustable tensioning means for applying tension to and releasing tension from said elongated member, application of tension by said tensioning means drawing said elongated member around said pipe, and release of tension by said tensioning means releasing said pipe from said elongated member.

23. In combination, a guide and a guide follower, said guide being positionable around a pipe for guiding a cutting device used to cut said pipe, said guide follower being mountable on said cutting device, said guide comprising:
a flexible, elongated member having first and second ends oppositely disposed, said elongated member being positionable substantially surrounding said pipe;
a plurality of guide bodies mounted on said elongated member, each of said guide bodies having an edge portion positionable projecting away from said pipe and being aligned with one another;
a first jaw portion engaged with said first end of said elongated member;
a second jaw portion engaged with said second end of said elongated member, said first and second jaw portions being movable toward one another to draw said elongated member around said pipe, said first and second jaw portions being movable away from one another to release said pipe from said elongated member; and
wherein said guide follower comprises an open channel having a width sized to receive said edges of said guide bodies.

24. A combination guide and guide follower according to claim 23, wherein each of said guide bodies further comprises a surface portion engageable with said pipe.

25. A combination guide and guide follower according to claim 23, wherein one of said first and second jaw portions is releasably engageable with one of said ends of said elongated member.

26. A combination guide and guide follower according to claim 23, wherein said elongated member comprises a chain.

27. A combination guide and guide follower according to claim 26, wherein each of said guide bodies comprises a disk.

28. A combination guide and guide follower according to claim 27, wherein said disks are rotatably mounted on said chain.

29. A combination guide and guide follower according to claim 23, wherein said first and second jaw portions are mounted on a pair of locking pliers, said first and second jaw portions being movable toward one another upon closing of said pliers to draw said elongated member around said pipe, said first and second jaw portions being movable and away from one another upon opening of said pliers to release said pipe from said elongated member.

30. A guide follower mountable on a tool and engageable with a guide having an edge extending outwardly therefrom, said guide follower comprising an elongated channel having a first flange attachable to said tool, and a second flange positioned in spaced relation to said first flange thereby defining a space between said first and said second flanges, said space being sized so as to receive said edge of said guide between said flanges for guiding said tool in a direction along said guide.
